(19) United States
(12) Patent Application Publication
(10) Pub. No.: US 2026/0305566 A1
(43) Pub. Date: Oct. 8, 2026

(54) LIVE ANIMAL TRANSPORTATION CONTAINER AND METHODS OF ASSEMBLY AND USE

(71) Applicant: Charles River Laboratories, Inc., Wilmington, MA (US)

(72) Inventors: John Denier, Wilmington, MA (US); Steven Reiter, Wilmington, MA (US)

(21) Appl. No.: 19/577,689

(22) Filed: Mar. 25, 2026

Related U.S. Application Data
(60) Provisional application No. 63/784,506, filed on Apr. 7, 2025.

(51) Int. Cl. A01K 1/02

(52) U.S. Cl. CPC A01K 1/0245

(57) ABSTRACT

Devices disclosed herein include a container having a base and lid defining an interior volume for receiving animals for transport. A device includes a lid having a first layer, a transparent layer, and a support layer, wherein the first layer may have at least one opening for viewing animals in the interior volume through the at least one opening, an access area for accessing the transparent layer and/or the interior volume, and a removable tear strip for configured to allow the access area to assume a fold, the support layer configured cover the at least one opening, preventing damage to the transparent layer. Methods disclosed herein may include the assembly, transport, and/or use of a container, where the devices and methods disclosed are configured to reduce the noise and/or vibrations transmitted to and sensed by animals in the interior volume container.

### FIELD OF INVENTION

The present disclosure generally relates to devices and methods for transporting live animals. In particular, the disclosure relates to containers for transporting live animals, kits including the containers, and methods of assembly and use of the containers.

### BACKGROUND

Animal models are central to the biomedical research field, helping scientists and researchers understand diseases and biological systems. Further, animal models are paramount in the pharmaceutical industry as they are used for drug efficacy and safety testing. These models often require particular breeds of animals or animals with specific genetic characteristics which are difficult to obtain, necessitating sourcing and shipping of the research animals in special transportation containers. The containers are designed to provide a safe and secure method of transporting the animals from one location to a second location. The transportation boxes must provide a secure enclosure that is resistant to escape, ensures for the safety and well-being of the animals throughout the transport, and prevents the spread of diseases and pathogens. Even upon meeting these criteria, many of the currently used containers may cause undue trauma or stress to the animals during one or more aspects of the transport, including during the removal from the container. Stress is known to potentially cause trauma or induce behavioral changes, hormonal changes, or other undesirable responses in the animals. These changes are particularly adverse since they may cause lingering effects which could alter the subsequent experiments. For these reasons and to improve the reliability and usefulness of animal experiments, it is important to minimize the stress and trauma that research animals experience during transportation.

In one aspect, animal transportation containers are often designed around providing a secure enclosure with less thought given to the process of removing the animals from the containers. Opening these containers can often be awkward and clunky, causing a user to excessively maneuver the container to open it. In other cases, the containers may require ripping or tearing of the box which may generate loud noises, strong vibrations, or sudden jolts to the container. Subjecting the animals to these conditions can cause the stress responses discussed above, potentially interfering with the research models.

### SUMMARY

One type of animal transportation container consists essentially of a rectangular box and a fitted lid secured to the box. The container may be constructed of cardboard, plastic, or other relatively affordable materials, since the container is constructed for single use. The single-use container is not equipped with a reusable locking mechanism for opening and closing the container. Instead, affordable, semi-permanent solutions, like stapling a cardboard lid to a container base may be used. To open the container, rather than removing the staples or other semi-permanent closure, the lid may be provided with a perforation which can be torn to create an opening in the lid to remove the animal(s) after transportation. The tearing of the perforations can often shake or vibrate the transportation container, or otherwise emit loud noises into the transportation container, potentially frightening or causing stress to the animals. In containers without perforations or in containers with more difficult means of opening, there may be even more shaking of the container or noise generated during the opening process.

Therefore, there is a need for a container for transporting live animals that reduces potential trauma and stress to the animals during aspects of use, in particular during the opening of the container. In some aspects, it is an object of this disclosure to provide low-stress environments for live animal transportation. In some aspects, it is an object of this disclosure to provide transportation containers and methods of use which generate less noise during opening of the container as compared to conventional transport containers. In some aspects, it is an object of this disclosure to provide transportation containers and methods of use which generate less vibrations during opening of the container as compared to conventional transport containers. In some aspects, it is an object of this disclosure to provide transportation containers and methods of use which reduce the transmission of noise and/or vibrations to an interior volume of the container.

In an embodiment, a container for transporting live animals is provided. The container comprises a base, a lid, and an interior volume defined by the base and the lid. The lid includes an access area which may provide an access to the interior volume of the container. The lid may further include at least one opening forming a viewing window such that a portion of the interior volume is visible through the at least one opening. The lid may further include a removable tear strip operably connected to the access area.

In further embodiments, the lid may comprise a first layer. In some embodiments, the access area, viewing window, and removable tear strip may be formed in the first layer. In some embodiments, the access area of the container is configured to fold away from the interior volume to provide access to the interior volume of the container. In some embodiments, the access area is configured to fold after the removable tear strip is removed from the first layer. In some embodiments, the access area is defined by three perforated sides and a fourth side, and is configured to fold about the fourth side. In some embodiments, one of the perforated sides includes the removable tear strip. In some embodiments, the fourth side is a non-perforated side.

In further embodiments, the lid includes a transparent layer and/or a support layer. In some embodiments, the transparent layer and/or the support layer may be secured to an inside surface of the first layer. In some embodiments, the support layer may be configured to protect or provide structural support to the lid and/or the viewing window in the lid. The support layer may be further configured to reinforce additional areas of the lid or substantially the entire lid. In some embodiments, the transparent layer may be configured to cover at least an entire area of the one or more openings. In some embodiments, the transparent layer may be configured to cover substantially the entire inner surface of the lid. In some embodiments, the transparent layer may be configured as an innermost layer of the lid, which is disposed towards the interior volume of the container, and which is configured to isolate the interior volume of the container. In some embodiments, the base of the container may also be provided with additional layers in one or more areas.

In embodiments, the removable tear strip provides a simple and easy way for a user to open the lid of the container without stressing one or more animas disposed within the container. In some embodiments, the removable tear strip is configured to detach from the lid, separating at least one of the sides of the access area from the lid once the tear strip is removed. In some embodiments, removal of the tear strip may allow the access area to freely fold upwards. In some embodiments, removal of the tear strip may allow a user to tear additional perforations in the access area until the access area can be folded upwards.

In some embodiments, the transparent layer of the lid may be configured to provide soundproofing and insulate the interior volume from exterior noises, such as the noises generated during removal of the removable tear strip. In some aspects, the transparent layer of the lid may be configured to attenuate acoustic vibrations transmitted from the first layer and/or removable tear strip to the interior volume of the container. In some aspects, the transparent layer may be configured to partially absorb acoustic vibrations generated from the first layer and/or removable tear strip during removal of the tear strip. In some aspects, the transparent layer may be configured to partially deflect acoustic vibrations from the first layer and/or removable tear strip during removal of the tear strip.

Thus, containers according to embodiments herein are advantageously configured to meet several of the disclosed objects of the disclosure. For example, a container according to embodiments herein is configured to be easy for a user to open. One or more removable tear strips provide a simple, reliable, and user-friendly method of opening the container. The one or more removable tear strips may require less force to open and/or result in less noise, shaking, and maneuvering of the container in order to open it than other known methods. Furthermore, the one or more openings and the transparent layer provide several functions. The transparent layer contributes to the soundproofing of the interior volume of the container while also providing a viewing window to the interior volume through the one or more openings in the lid. For some types of animal transportation, it may be required to have one or more viewing windows into the interior volume of the container due to government regulations. In the embodiments discussed herein, the use of the transparent layer, support layer, and/or one or more openings, or any combination thereof, advantageously provide the viewing window in the lid, provide support to the viewing window, reduce shaking and manipulation of the container during the opening procedure, and/or may improve the soundproofing of the interior volume, protecting the one or more animals throughout various stages of the transportation. In particular, the tear strip requires minimal force to remove and can be performed without a user having to inadvertently shake or disturb the container during the removal. When the tear strip has been removed, the transparent layer may be sliced or cut to allow access the interior volume of the container. This step causes virtually no disturbances to the containers or the one or more animals therein. Thus, the container having a lid with perforated, removable tear strip and a transparent layer is configured to reduce the stress caused to one or more animals in the container during the opening of the container.

In further embodiments, the first layer of the lid comprises a central, main portion and flaps extending from the main portion. In some embodiments, the main portion is provided in a rectangular shape, and the lid comprises four flaps extending from each side of the main portion. In some embodiments, the transparent layer is configured to cover an entire area of the main portion.

In further embodiments, the support layer is disposed between the first layer and the transparent layer. In further embodiments, the support layer is secured to the access area of the first layer.

In further embodiments, the support layer comprises a first support layer and a second support layer. In some embodiments, the second support layer is configured to overlap a portion of the first support layer. In some embodiments, the first support layer and the second support layer together cover an entire area of the main portion of the first layer.

In some embodiments, the transparent layer is configured to cover substantially of the first support layer and the second support layer.

In embodiments, the first layer is composed of a corrugated or fluted cardboard or fiberboard. In some embodiments, the first layer may be reinforced with additional fibers or materials. In some embodiments, the first layer may contain axially oriented fibers. In some alternate embodiments, the first layer is composed of a corrugated plastic board.

In embodiments, the transparent layer is composed of a plastic film. In embodiments, the transparent layer is composed of a polyester, polypropylene, nylon, polycarbonate, PVC, PTFE. In some embodiments, the transparent layer is composed of an oriented or biaxially oriented film. In some embodiments, the transparent layer is composed of biaxially oriented polyethylene terephthalate, e.g. mylar. In further embodiments, other plastic films exhibiting high tensile strength and transparency may be used for the transparent layer.

In embodiments, the support layer is composed of a screen or mesh. In embodiments, the support layer is composed of a metal, fiberglass, and/or plastic mesh.

In further embodiments, the interior volume of the container comprises a first interior wall separating the interior volume into a first subvolume and a second subvolume separate from the first subvolume. In further embodiments, the interior volume further comprises a second interior wall separating the interior volume into a third subvolume separated from the first subvolume and the second subvolume. In still further embodiments, the interior volume may comprise additional interior walls and subvolumes.

In some embodiments, each subvolume is visible through the viewing window in the first layer. In various embodiments, the viewing window may comprise one opening, two openings, or more than two openings. In various embodiments, each subvolume is visible through the viewing window via at least one of the openings. For example, a first subvolume may be visible through a first opening of the at least one opening and a second subvolume may be visible through a second opening of the at least one opening.

In further embodiments, the base of the container includes a first panel and a plurality of sidewalls extending substantially perpendicularly from the first panel towards a top end of the base. In further embodiments, each sidewall of the plurality of sidewalls includes a flange extending substantially perpendicular to the sidewall. In some embodiments, the flaps of the lid are configured to surround the flanges, such that the flaps of the lid can be secured or attached to the flanges. In some embodiments, the lid may receive or be configured to receive mechanical fasteners to fix the flaps of the first layer to the flanges.

In further embodiments, the base further includes a base perforation extending around the base. The base perforation may be disposed towards a top portion of the base and configured to allow the flanges of the base to be removed from the sidewalls. In some embodiments, the lid and flanges of the base are configured to be together removed from the base when the lid is mechanically fastened to the top portion of the base. In some embodiments, the lid and flanges of the base are configured to be removed when a user tears the base perforation of the base.

In further embodiments, the base of the container may also be provided with additional soundproofing or insulating layers. In some embodiments, the additional layers may be similar to the transparent layer of the lid. In some embodiments, the additional layers may be different from the transparent layer of the lid and may comprise a foam, expanded plastic, or other insulating material known in the art.

In some embodiments, the lid may have a main portion with an area up to about 425 in². In some embodiments, the access area has an area which is at least 40% of an area of the main portion of the first layer. In some embodiments, the access area has an area which is about 50%, 55%, or 60% of an area of the main portion of the first layer. In further embodiments, the viewing area in the first layer has a total area in the range of about 22-35 in². In some embodiments, viewing area comprises two openings, each opening in the viewing area has an area in the range of about 11-16 in². In some embodiments, the first layer comprises two or more openings.

In a further embodiment, a method of assembling a container is provided. The method includes assembling a base, disposing a lid on the base, and securing the lid to the base. In some embodiments, the assembling includes folding a plurality of sidewalls of the base perpendicularly from a first panel of the panel. In some embodiments, the assembling further includes folding flanges perpendicularly to the sidewalls to form a base flange. In some embodiments, the method further includes wrapping flaps of the lid around the base flange. In some embodiments, the securing further includes inserting one or more fasteners through the flaps of the lid and the base flange. In some embodiments, the method further includes placing a pad in the base before securing the lid to the base. In embodiments, the method further comprises placing one or more animals in the base before securing the lid to the base. In some embodiments, the method further comprises placing one or more interior walls in the base before securing the lid to the base. In some embodiments, the method further includes fastening at least one filter to an interior surface of the base. In some embodiments, the method further includes covering at least one filter opening in the sidewalls of the base with the at least one filter. In some embodiments, the method further includes fastening a filter support layer to the interior surface of the base, covering the at least one filter.

In a further embodiment, a method of assembling a lid for a container is provided. The method includes providing a first layer comprising at least one opening and a removable tear strip; fastening a support layer to the first layer covering the at least one opening; and fastening a transparent layer to the first layer covering the support layer.

In a further embodiment, a method of assembling a lid for a container is provided. The method includes providing a first layer comprising at least one opening and a removable tear strip; fastening a first support layer to the first layer covering the at least one opening; fastening a second support layer to the first layer covering a portion of the first layer; and fastening a transparent layer to the first layer covering the first support layer and the second support layer.

In a further embodiment, a lid for a container is configured to be stored in a flat configuration and self-assembled by a customer. The lid for the container and the components thereof are provided to the customer such that the lid may be efficiently stored in the flat configuration and assembled when one or more animals are ready to be shipped in the container. In some embodiments, a first layer of the lid may be stored in a flat configuration and a first and/or second support layer and a transparent layer may be fastened to the first layer when one or more animals are ready to be shipped in the container. In some embodiments, the first and/or second support layer and the transparent are fastened to the first layer, and the lid is then stored in a flat configuration. In this way, the customer can efficiently store a plurality of lids or components thereof, and complete the assembly of one or more lids once one or more animals are ready to be transported.

In a further embodiment, a base for a container is configured to be stored in a flat configuration and self-assembled by a customer. The base for the container and the components thereof may be provided to the customer such that the base can be efficiently stored in the flat configuration and assembled when one or more animals are ready to be shipped in the container. In some embodiments, the base may be stored in a flat configuration and filters, interior walls, pads, and/or support layers may be stored separately and inserted or fastened to the base when one or more animals are ready to be shipped in the container. In some embodiments, filters and/or support layers are fastened to the base, and the base is then stored in a flat configuration. In this way, the customer can efficiently store a plurality of bases or components thereof, and complete the assembly of one or more bases once one or more animals are ready to be transported.

In a further embodiment, a method of preparing a container for shipment is provided. The method includes providing a container according to any embodiment herein; placing one or more animals into the interior volume of the container; and securing the lid of the container to the base of the container. The method may further include preparing a bedding in a bottom of the container. The method may further include providing a food source in the container. The method may further include providing a water source in the container. The method may further include placing interior walls in the container. The method may further include assembling the container in any manner described in this disclosure.

In a further embodiment, a method of retrieving an animal from a container is provided. The method includes receiving a container according to any embodiment herein; and removing at least one animal from the interior volume of the container. The removing step may further include opening the container; exposing the transparent layer of the lid; cutting the transparent layer of the lid; and removing the at least one animal through the cut in the transparent layer. The opening step of the method may further include removing a removable tear strip from the lid of the container. The opening and/or exposing steps of the method may further include lifting and/or folding an access area of the lid of the container. In a further embodiment, the cutting of the transparent layer is performed with a cutting implement provided with the container. In a further embodiment, the container and the cutting implement are provided together in a kit.

In a further embodiment of the invention, a kit for transporting live animals is provided. In some embodiments, the kit comprises a container and a cutting implement. In some embodiments, the kit comprises a container according to any of the embodiments described herein. In some embodiments, the kit comprises a base and a lid to be assembled into a container, the lid configured to fasten to the base to define an interior volume. In some embodiments, the cutting implement is provided for cutting a transparent layer of the lid.

As used herein, the term “animal” is not particularly limited but may refer to any mammal, including, but not limited to, a cat, a dog, a rodent, a rabbit, a pig, a goat, a sheep, etc.

As used herein, the term “container” may refer to any rigid enclosure suitable for transportation. In some cases, a container may be a rectangular box enclosure. In other cases, a container may be formed in other shapes provided the container has a flat bottom and an interior volume for one or more animals. In some cases, a container is provided with a separate base and lid. In other cases, a container may have a base with a folding lid or door in one or more of the faces. In some cases, a container may be a cage.

As used herein, the term “bedding” may refer to material which is used in a bottom of the container to provide a comfortable floor covering for the one more animals in the container. Bedding may be composed of straw, wood chips, wood or paper shavings, and other materials which appropriately provide a bedding surface. Bedding materials should be configured to absorb moisture and/or excretions, absorb odors, provide warmth and insulation, and satisfy or be safe in consideration of other needs of the one or more animals such as digging, foraging instincts, etc. One of ordinary skill in the art may select bedding materials specifically for the one more animals to be transported in the container as appropriate.

### BRIEF DESCRIPTION OF THE DRAWINGS

The foregoing and other objects, features, and advantages will be apparent from the following description of the embodiments, as illustrated in the accompanying drawings. The drawings are not necessarily drawn to scale, emphasis instead being placed upon illustrating the principles of the embodiments. In the drawings, each identical or nearly identical component that is illustrated in various embodiments and different views is represented by a like numeral. For purposes of clarity, not every component may be labeled in every drawing. In the drawings:

FIG. 1 illustrates a perspective view of an assembled transportation container according to an embodiment of the invention.

FIG. 2A illustrates a top view of a lid for a transportation container according to an embodiment of the invention.

FIG. 2B illustrates a schematic view of the first layer of the lid of FIG. 2A.

FIG. 3 illustrates an exploded view of the lid of FIG. 2A.

FIG. 4 illustrates a schematic view of the assembled lid of FIG. 3.

FIG. 5 illustrates an exploded view of a lid according to an embodiment of the invention.

FIG. 6 illustrates a schematic view of the assembled lid of FIG. 5.

FIG. 7 illustrates a view of a base for a transportation container according to an embodiment of the invention.

FIG. 8 illustrates a view of the interior volume of transportation containers according to two embodiments of the invention.

FIG. 9 illustrates a perspective view of an assembled transportation container and cutting implement according to an embodiment of the invention.

FIG. 10 illustrates a schematic view showing the dimensions of the first layer of a lid according to a first example embodiment.

FIGS. 11A and 11B illustrate an example embodiment similar to FIGS. 3-4 as used with the first layer embodiment of FIG. 10.

FIGS. 12A-12C illustrate an example embodiment similar to FIGS. 5-6 as used with the first layer embodiment of FIG. 10.

FIGS. 13A-13D illustrate steps of opening an example embodiment of the container.

### DETAILED DESCRIPTION

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques).

Embodiments of the present disclosure are directed to systems and methods relating to the transport of live animals.

Live animal shipping containers are regulated by various entities, such as the International Air Transport Association (IATA) which provides the Live Animal Regulations (LAR) as a worldwide standard for shipping live animals on commercial aircraft. Containers for shipping live animals may be required to comply with LAR, or other rules and/or regulations depending on the age, condition, or type of animals being transported, the mode of transport, the length of transport, and the originating and destined locations. Containers according to embodiments herein may be configured to comply with any and all rules and regulations governing aspects of the transportation containers by providing escape resistant enclosures including appropriate air filters, viewing windows, water sources, food sources, bedding materials, and/or other requirements, as necessary.

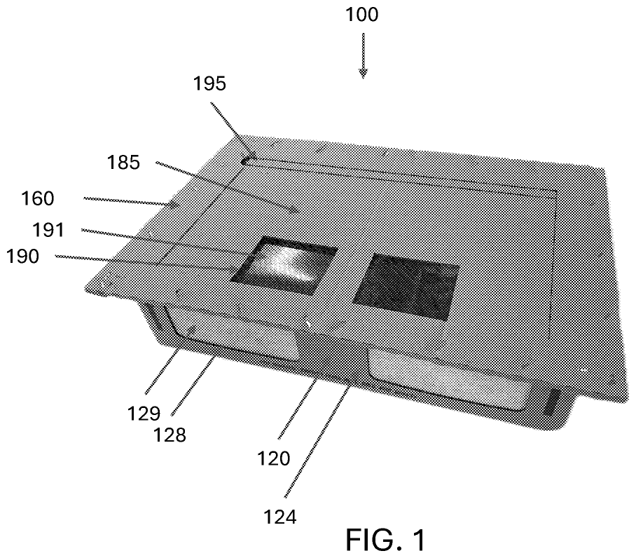

Referring now to FIG. 1, an embodiment of a container 100 for transporting live animals is depicted. The container 100 includes a base 120 and a lid 160. The lid 160 is configured to be secured to the base 120 to define an interior volume of the container 100 where the interior volume is large enough to house one or more live animals. In some embodiments, the base 120 and the lid 160 may each be equipped with one or more openings for various purposes. For example, the base 120 may be equipped with at least one filter opening 128 which is intended to receive a filter. Filtered openings in the container 100 provide adequate airflow and sufficient oxygen to the one or more animals during transportation and also prevent the spread of diseases or pathogens that may be carried by the one or more animals. The lid 160 is also equipped with at least one opening 190. The at least one opening 190 is provided to create a viewing window 191 into the interior volume of the container 100 to allow the one or more animals to be viewed. The lid 160 of the container 100 further includes an access area or access portion 185 which can be opened following the removal of a removable tear strip 195.

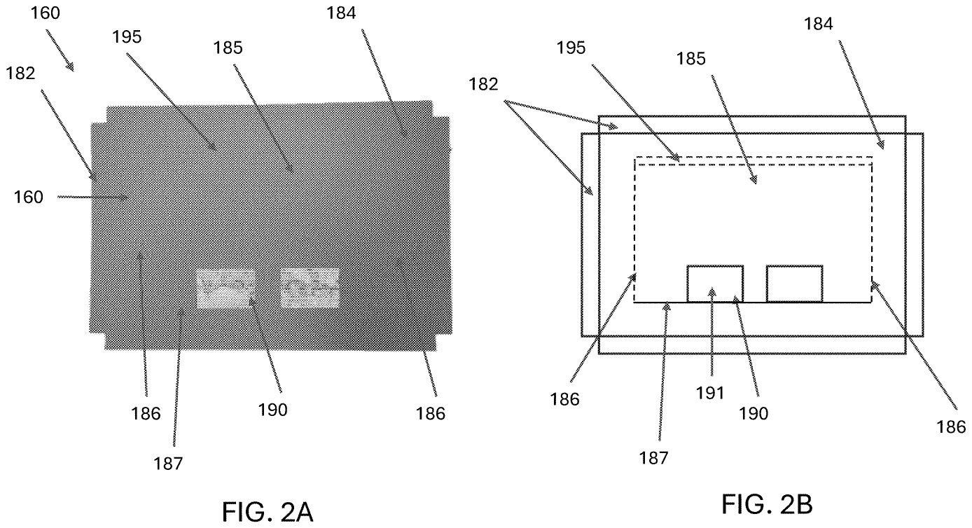

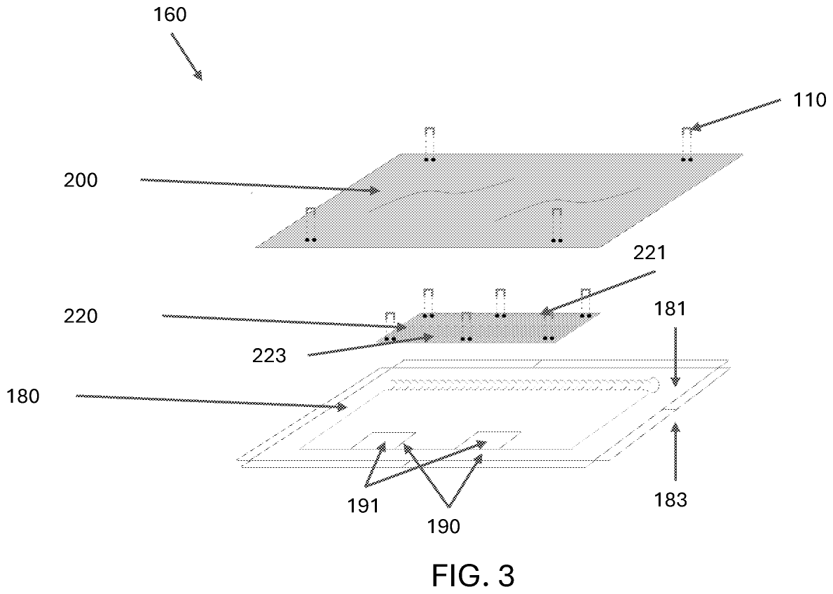

Now referring to FIGS. 2A-2B, top views of the lid 160 for container 100, prior to being secured to the base 120, are depicted. The lid 160 includes a main portion 184 which is a substantially flat panel formed in a rectangular shape and is designed to form the top of the container 100. The lid 160 further includes flaps 182 extending from the main portion 184 which are configured to fold and secure to the base 120 of the container 100. The lid 160 further includes the access portion 185. In some embodiments, as shown in FIG. 2B, the access portion 185 may be defined by perforated sides 186 and another side 187. The other side 187 may be a non-perforated side. The access portion 185 may further be defined by the removable tear strip 195 on one of its sides. In other words, the removable tear strip 195 may be formed alongside one of the perforated sides 186 of the access portion 185. In this particular embodiment, the access portion 185 is formed in a rectangular shape, with the removable tear strip 195 provided opposite the other side 187. In further embodiments, the access portion 185 may be provided in a different shape. In this embodiment, the access portion 185 can be folded about the other side 187 after removal of the removable tear strip 195 and tearing of the rest of the perforated sides 186. With the perforated sides 186 separated, the access portion 185 forms a large flap and provides access to the interior volume of the container 100 when folded up. The lid 160 further includes at least one opening 190 forming a viewing window 191. In some embodiments, the at least one opening 190 may be formed in the access portion 185 of the lid 160. In some embodiments, the at least one opening 190 may be formed along the other side 187. In further embodiments, the at least one opening 190 and viewing window 191 may be formed elsewhere on the lid 160.

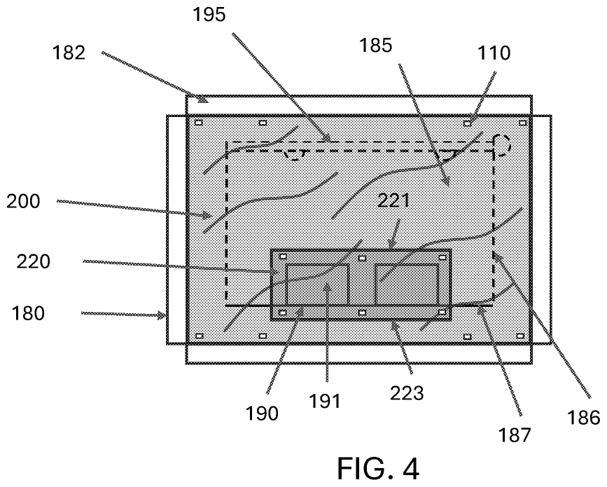

In some embodiments, the lid 160 may comprise multiple layers. With continued reference to FIGS. 2A-2B, each of the features shown, including the flaps 182, the access portion 185, the at least one opening 190, removable tear strip 195, may be provided in a first layer 180 of the lid 160. Referring now to FIG. 3, an exploded view of an embodiment of the lid 160 is depicted. The lid 160 includes a first layer 180, a transparent layer 200, and a support layer 220 therebetween. The transparent layer 200 and support layer 220 are disposed on an interior surface 181 of the first layer 180 such they are oriented towards the interior volume of the container 100 when the lid 160 is secured to the base 120. The first layer 180 has an exterior surface 183 which is substantially identical to the interior surface 181. However, the exterior surface 183 may be provided with printed markings, instructions, and labels. Thus, the transparent layer 200 and support layer 220 should be secured to the interior surface 181 of the first layer 180 which is intended to face into the interior volume of the container 100. In some implementations, the transparent layer may be a sheet or film of a polymer, plastic, and/or polyester resin, e.g. mylar.

The transparent layer 200 and the support layer 220 may be secured to the first layer 180 via fasteners 110. The fasteners 110 can be staples or any other fastener with sufficient strength to secure the multiple layers of the first layer 180. In this embodiment, the at least one opening 190 includes two openings forming the viewing window 191. The support layer 220 is sized and configured to cover the two openings 190 and viewing window 191. The support layer 220 may be composed of [polyester, metal, etc.] and may be a film, a grate, a screen, or other reinforcing structure. Referring back to FIG. 1, it can be seen that the transparent layer 200 and/or support layer 220 in the area of the viewing window 191 are exposed to the exterior environment. Thus, the support layer 220 provides reinforcement to the area of the viewing window 191 such that the exposed transparent layer 200 is not torn, pierced, or otherwise punctured. The support layer 220 is further configured to prevent scratching, biting, and other damage to the components of the container that could otherwise occur from the one or more animals in the container.

The transparent layer 200 is secured to interior surface 181 of the first layer 180 on top of the support layer 220. The transparent layer 200 is sized and configured to cover at least the entire access portion 185 of the first layer 180. Furthermore, the transparent layer 200 is secured to the first layer 180 at points outside of the access portion 185. In other words, the transparent layer 200 is secured to the first layer 180 and covers the access portion 185 but it is not secured to the access portion 185. In this way, the support layer 220 is configured to move with the access portion 185 when the access portion 185 is folded up but the transparent layer 200 remains in place or otherwise stationary when the access portion 185 is folded up. Accordingly, when the container 100 is assembled and the lid 160 is secured to the base 120, the support layer 220 and the transparent layer 200 are exposed through the viewing window 191. From this configuration, when the removable tear strip 195 is removed and the access portion 185 is folded up to access the interior volume of the container, the transparent layer 200 in the vacated area of the access portion 185 still prevents access to the interior volume. The support layer 220 folds up with the access portion 185, leaving a larger area of the transparent layer 200 exposed and with the transparent layer 200 keeping the interior volume of the container 100 enclosed. The transparent layer 200 can then be sliced, cut, or otherwise opened to access the interior volume to remove the one or more animals.

Referring back to FIG. 1, in this embodiment, the transparent layer 200 is permanently exposed through the at least one opening 190. In other words, the lid 160 does not include any flaps or covers which can cover or obscure the viewing window 191. Accordingly, the interior volume of the container 100 is necessarily visible through the at least one opening 190 and viewing window 191 at all times. Still referring to FIG. 1, each opening of the at least one opening 190 is formed in a square shape, and each side of the squares are cut into the first layer 180. In some embodiments, the openings in the at least one opening 190 may be provided in other shapes. For example, the at least one opening 190 may be provided as a single rectangular opening. Additional shapes for the at least one opening 190 are further contemplated.

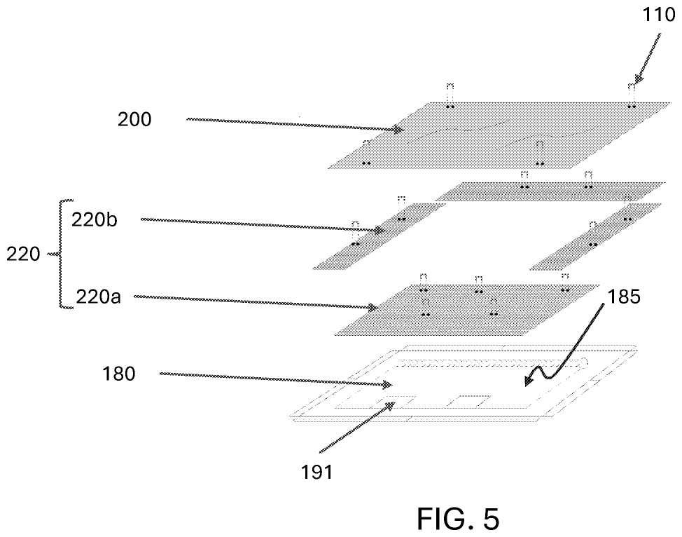

FIG. 4 illustrates the layers of FIG. 3 in the assembled configuration when viewing the interior surface 181 side of the lid 160. FIG. 4 also illustrates an example of the placement of the fasteners 110. A first edge 221 of the support layer 220 is fastened to the first layer 180 inside the access portion 185 and a second edge 223 of the support layer 220 is fastened to the first layer 180 outside the access portion 185. All fasteners 110 for the transparent layer 200 are placed outside the access portion 185.

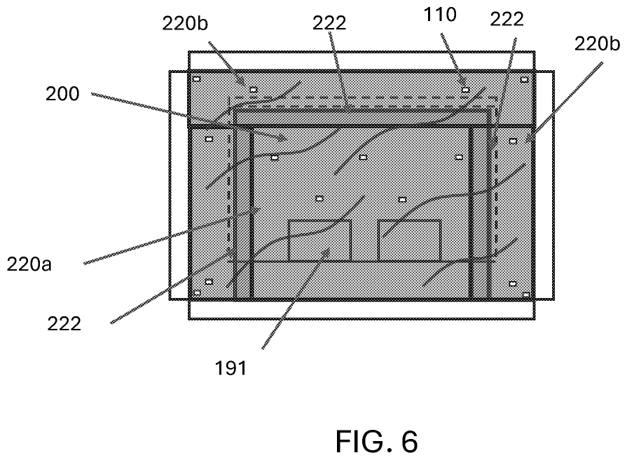

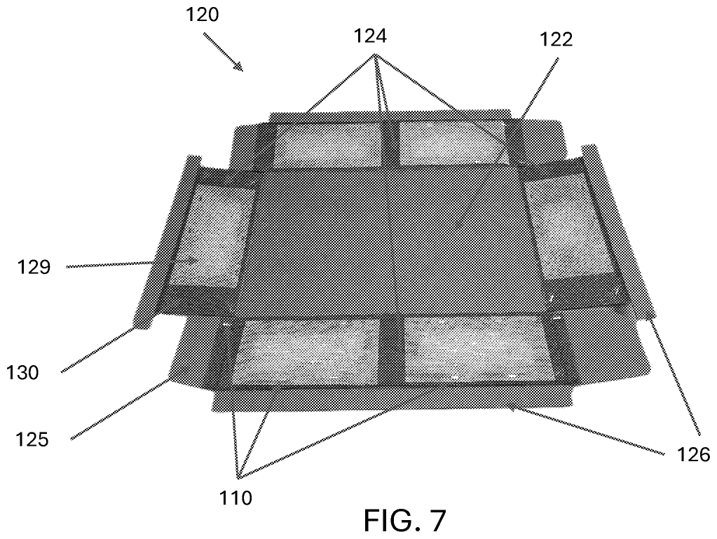

In some embodiments, it may be beneficial to provide a support layer to reinforce the entire lid 160. Referring now to FIG. 5, an embodiment is illustrated wherein the support layer 220 comprises a first support layer 220a and a second support layer 220b. In the depicted embodiment, the first support layer 220a is sized and configured to cover the viewing window 191 and substantially all of the access portion 185. The second support layer 220b is sized and configured to cover the outer portions of the first layer 180 outside of the access portion 185 and also creates an overlap 222 (see FIG. 6) with the first support layer 220a. In FIG. 5, the second support layer 220b comprises three separate panels that are placed together to cover the outer portions of the first layer 180 outside of the access portion 185. In some embodiments, the second support layer 220b may be formed from a single U-shaped panel or rectangular panels arranged in a U-shape. In some embodiments, the support layer 220 may comprise a different shape or a different number of panels. The first support layer 220a is secured to the access portion 185 of the first layer 180 while each panel of the second support layer 220b is secured outside the access portion 185. The second support layer 220b overlaps with the first support layer 220a to ensure that the entire first layer 180 is reinforced by either the first support layer 220a or second support layer 220b. Furthermore, the sizing and placement of the first support layer 220a and support layer 220 preserve the functionality of the access portion 185. Accordingly, when the container 100 is assembled and the lid 160 is secured to the base 120, the first support layer 220a and the transparent layer 200 are exposed through the viewing window 191. From this configuration, when the removable tear strip 195 is removed and the access portion 185 is folded up, the first support layer 220a folds up with the access portion 185, leaving the transparent layer 200 exposed in the vacated area of the access portion 185 and the transparent layer 200 keeping the interior volume of the container 100 enclosed. Additionally, a portion of the overlapping part of the second support layer 220b may also be exposed when the access portion 185 is folded up, but the majority of the transparent layer 200 will be exposed such that the transparent layer 200 can still be sliced, cut, or otherwise opened to access the interior volume to remove the one or more animals.

FIG. 6 illustrates the layers of FIG. 5 in the assembled configuration when viewing the interior surface 181 side of the lid 160. FIG. 6 also illustrates an example of the placement of the fasteners 110. The first support layer 220a is fastened to the first layer 180 inside the access portion 185, all fasteners 110 for the support layer 220 are placed outside the access portion 185, and all fasteners 110 for the transparent layer 200 are also placed outside the access portion 185.

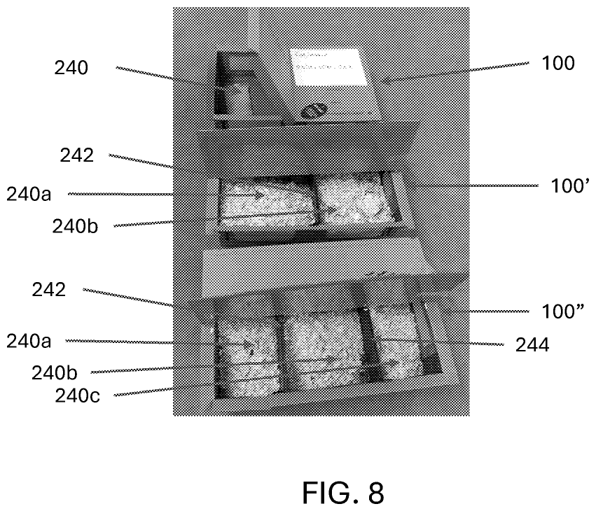

Referring now to FIG. 7, an embodiment of the base 120 of the container 100 is illustrated. The base 120 includes a first panel 122 and a plurality of sidewalls 124 extending from the first panel 122. In this embodiment, the first panel 122 is rectangular and the plurality of sidewalls 124 include four sidewalls extending from each side of the first panel 122. Each of the plurality of sidewalls 124 have a width at least as wide as the side of the first panel 122 which they extend from. Some of the plurality of sidewalls 124 may have extensions 125 such that the sidewalls have a width which extends wider than the side of the first panel 122 which they extend from. In this embodiment, two of the plurality of sidewalls 124 are equipped with extensions 125 and two of the plurality of sidewalls 124 are formed without extensions 125. The extensions 125 are provided to allow the plurality of sidewalls 124 to be secured to each other to create a three-dimensional base 120. In some embodiments, the extensions 125 may be fastened or secured to an outer surface of adjacent sidewalls 124. The extensions 125 may alternatively be fastened or secured to an inner surface of the adjacent sidewalls 124. In some embodiments, fasteners 110 are used to secure the extensions 125 to the adjacent sidewalls 124. In some embodiments, alternate fasteners or adhesives are used to secure the extensions 125 to an adjacent sidewall 124. The extensions 125 may vary in size, but are sized and configured to provide a sufficiently strong connection between the sidewalls 124.

As shown in FIG. 1, each of the plurality of sidewalls 124 may be provided with at least one filter opening 128 to receive a filter 129. The container 100 must be provided with filtered openings in the container 100 provide sufficient airflow in and out of the container. Thus, the filtered openings should provide adequate air exchange to the interior volume of the container 100 while preventing the spread of diseases or pathogens that may be carried by the one or more animals. In some embodiments, each of the at least one filter opening 128 are cut into the plurality of sidewalls 124. Referring back to FIG. 7, the filter 129 may be fastened or secured to an inner surface of the plurality of sidewalls 124 to cover the at least one filter opening 128. In some embodiments, an adhesive is used around the periphery of the at least one filter opening 128 to attach the filter 129 in order to substantially prevent airways which bypass the filters 129 through the at least one filter opening 128. The extensions 125 of the sidewalls 124 are also sized such that they do not cover or block the at least one filter opening 128 or filters 129.

Referring back to FIG. 7, a support 130 is further secured over the filters 129 on the plurality of sidewalls 124. The support 130 may be made of the same material as the support layer 220 in the lid 160. In some embodiments, the support 130 may be a different material. In some embodiments, fasteners 110 may be used to secure the support 130 to the plurality of sidewalls 124. In some embodiments, when the base 120 is assembled, an entire inner surface of the plurality of sidewalls 124 may be protected by the support 130.

In some embodiments, the base 120 further includes a pad which is placed on the first panel 122 of the base 120. A pad (not shown) provides additional strength to the first panel 122 and the bottom of the container 100 which must carry the weight of the one or more animals and the food, water, bedding, and other contents of the container. In some embodiments, the pad absorbs extra moisture such that the first panel 122 does not become wet and weakened from water and/or animal excretions during transportation. In some embodiments, the pad prevents the one or more animals from being able to chew, scratch, or damage the first panel 122. The pad may be constructed from cardboard, and may include one layer, two layers, or more than two layers of cardboard adhered together. In some embodiments, the pad may have an additional support such as a film, a grate, a screen, or other reinforcing structure adhered to a surface of the pad.

Each of the plurality of sidewalls 124 are equipped with an additional flange panel 126. The flange panels 126 extend from the plurality of sidewalls 124 from an end of the sidewalls 124 opposite to the first panel 122. Each of the plurality of sidewalls 124 are configured to fold substantially perpendicularly to the first panel 122 and each of the flange panels 126 are also configured to fold substantially perpendicularly to the plurality of sidewalls 124. Accordingly, when the first panel 122 is flat on the ground, the plurality of sidewalls 124 can be folded upwards and secured with the extensions 125 to create the main structure of the base 120. From this configuration, the flange panels 126 can be folded out to form a rim-like flange extending around the perimeter of the top of the base 120. When the plurality of sidewalls 124 are folded up and the flange panels 126 are folded out, the flange panels 126 provide a flat surface upon which the lid 160 can be placed and secured. In some embodiments, fasteners 110 are used to secure the lid 160 to the flange panels 126.

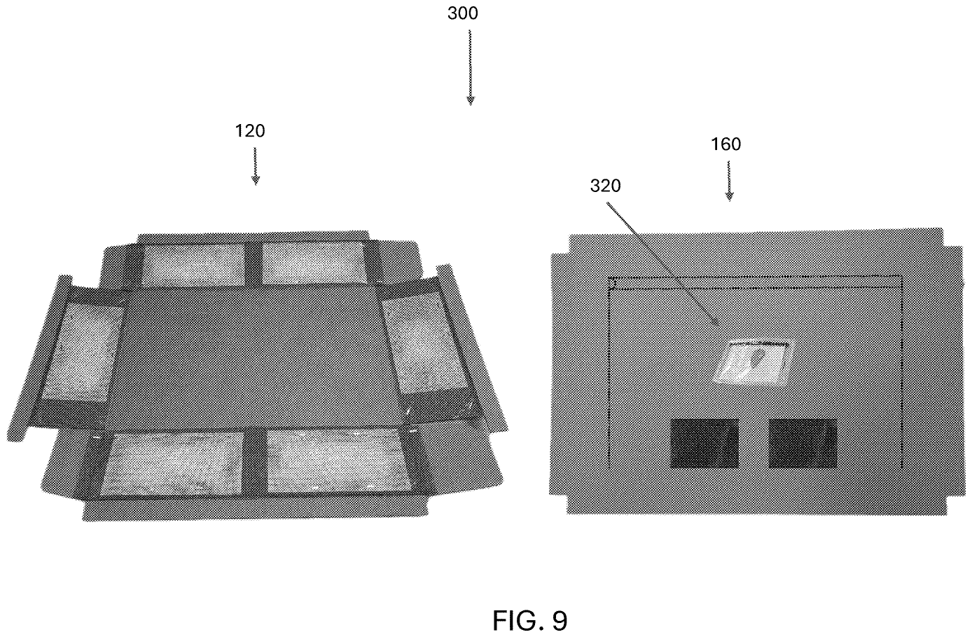

Referring now to FIG. 8, embodiments of the containers 100, 100′, 100″ are depicted which show the interior volume 240 of the containers 100, 100′, 100″. In some embodiments, the container 100′ may include a first interior wall 242 which subdivides the interior volume 240 of the container 100′ into a first subvolume 240a and a second subvolume 240b. In some embodiments, the container 100″ may include a second interior wall 244 which further subdivides the interior volume 240 into a third subvolume 240c. In some embodiments, the interior volume of the container 100, 100′, 100″ may include additional walls and additional interior subvolumes. Each of the interior subvolumes 240a-240c are separated from one another by the interior walls 242, 244 in the container 100′, 100″. The height of the interior walls 242, 244 may be approximately the same as the height of the plurality of sidewalls 124 of the base 120. That is, the interior walls 242, 244 extend from the first panel 122 to the lid 160. Therefore, each subvolume 240a-240c becomes fully enclosed and separated when the lid 160 is attached to the base 120. It may be beneficial to subdivide the interior volume in order to separate different species, breeds, cohorts, or groups of the one or more animals.

In various embodiments, each subvolume of the interior volume is visible from the viewing window 191 in the lid 160. For example, referring back to the embodiment of FIG. 1, the at least one opening 190 in the lid 160 includes two openings which are disposed symmetrically across the long dimension of the container 100, and towards one of the long sides of the container 100. In this embodiment, the interior volume 240 may be provided with a first interior wall 242 creating a first subvolume 240a and second subvolume 240b, where the first interior wall 242 approximately bisects the two long sidewalls 124 (see FIG. 8, container 100′). In this case, the first subvolume 240a will be visible through one of the two openings 190 and the second subvolume 240b will be visible through the other of the two openings 190.

Still referring to FIG. 8 and with continued reference to FIG. 1, the interior volume 240 of the container 100 may alternatively be provided with the first interior wall 242 and second interior wall 244, creating the first subvolume 240a, second subvolume 240 b, and third subvolume 240 c, where the first interior wall 242 and second interior wall 244 approximately intersect the two long sidewalls 124 (See FIG. 8, container 100″). In this case, the first subvolume 240a will be visible from one of the two openings 190, the third subvolume 240c will be visible from the other of the two openings 190, and the second subvolume 240b will be visible from both of the two openings 190.

In further embodiments, the at least one opening 190 may include a different number of openings and may be disposed at different locations in the lid 160. In any case, interior walls may be correspondingly placed in the interior volume such that at least a portion of each subvolume will be visible through at least one opening 190 in the lid 160. In some embodiments, each subvolume may be approximately the same size. In other embodiments, different subvolumes may be different sizes. Furthermore, each subvolume may be outfitted appropriately for the one or more animals to be placed in the respective subvolume. For example, each subvolume may receive the same bedding, food, water, and other contents. In other cases, different subvolumes may be supplied with different beddings, food sources, water sources, or other contents which are suitable in each case for the one or more animals to be placed in the respective subvolumes.

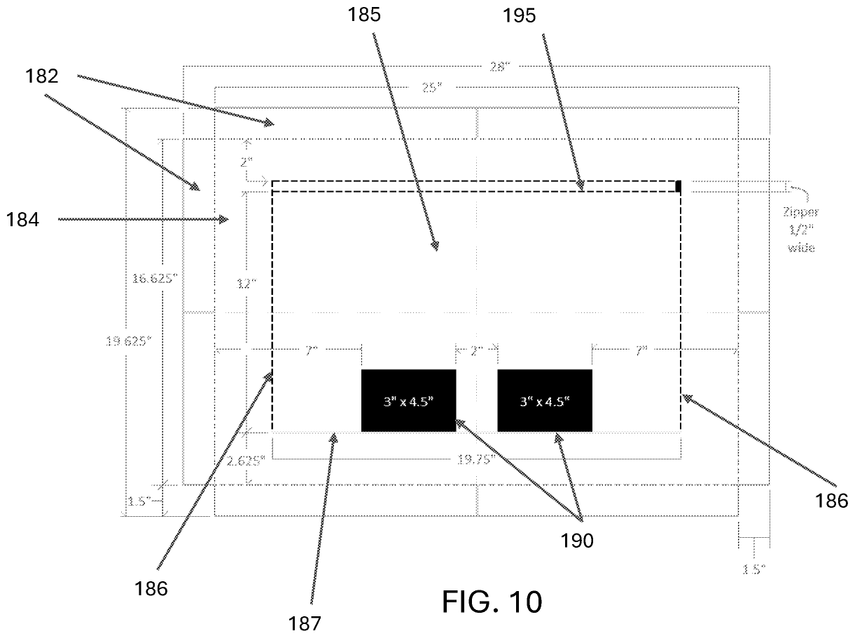

Referring now to FIG. 9, a kit 300 for assembling the container 100 including the base 120, the lid 160, and a cutting implement 320 is depicted. In the depicted embodiment, the lid 160 of the container 100 is outfitted with a pocket to hold the cutting implement 320. In further embodiments, any outer surface of the container 100 can be outfitted with a pocket to hold the cutting implement 320. In some embodiments, the pocket and cutting implement 320 are attached to an outer surface of the container before enclosing one or more animals in the container 100. In some embodiments, the pocket and cutting implement 320 are attached to an outer surface of the container after enclosing one or more animals in the container 100.

The cutting implement 320 can be any tool having at least a handle for a user to hold the cutting implement 320 and a blade for cutting. In some embodiments, the blade can be retractable into the handle. In some embodiments, the handle smoothly transitions to a sharpened blade. In some embodiments, the blade is formed separately and may be inserted into the handle. In some embodiments, the blade is formed from metal, ceramic, plastic, or any other hardened material which can be formed with a sharpened edge for cutting. In some embodiments, the handle of the cutting implement 320 is an ergonomic handle that approximately conforms to a user's grip.

### Methods of Assembly

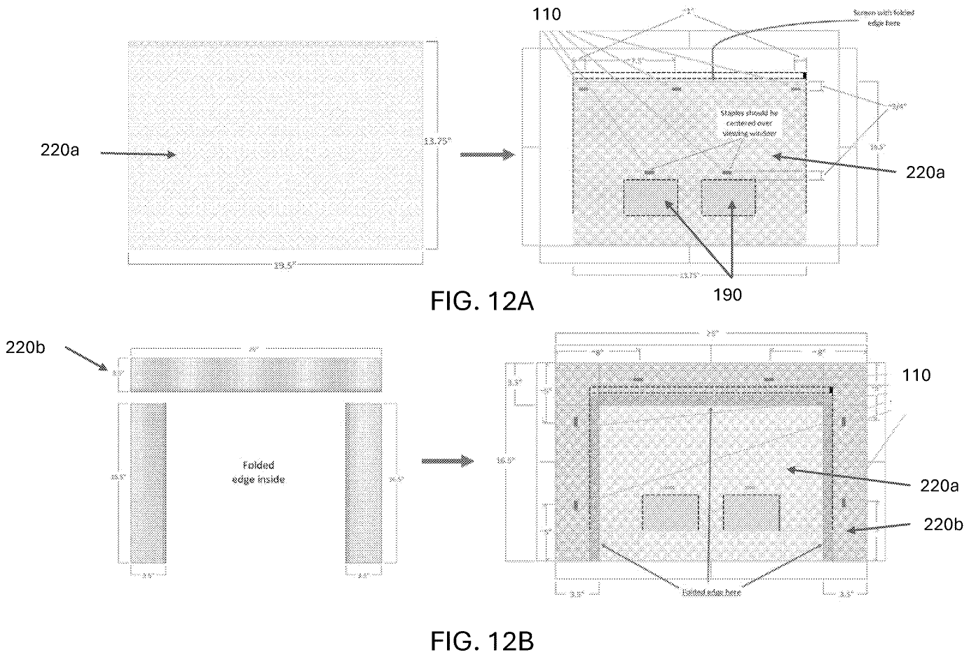

An example method of assembling a container is further discussed with references to the example embodiments in the figures. The method of assembling a container 100 includes constructing a base 120 and lid 160, assembling the constructed base 120, inserting one or more animals into the assembled base 120, and closing the container 100. Referring to FIG. 7 which shows a constructed base 120, the step of constructing the base 120 may further include securing a filter 129 over each of the filter openings 128. The constructing of the base 120 may further include securing a support 130 over each of the filters 129. Referring to FIGS. 11A-B, the step of constructing the lid 160 may further include securing the support layer 220 to the first layer 180. The constructing of the lid 160 may further include securing the transparent layer 200 to the first layer 180. In some implementations of the method, the base 120 and/or lid 160 may be constructed in other ways apparent to one of ordinary skill in the art.

Once the base 120 is constructed, as shown in FIG. 7, the base 120 may be assembled. The assembling of the constructed base 120 may further include folding a plurality of sidewalls 124 of the base 120 perpendicularly to a first panel 122 of the base 120. The assembling of the base 120 may further include folding and securing extensions 125 of sidewalls 124 to adjacent sidewalls 124. The assembling of the base 120 may further include folding flange panels 126 perpendicularly to the sidewalls 124 to form a flange. The assembling of the base 120 may further include inserting a pad into the bottom of the base 120 on top of the first panel 122. The assembling of the base 120 may further include inserting a first interior wall 242, second interior wall 244, and/or additional interior walls into an interior volume 240 of the container 100. In some implementations of the method, base 120 may be assembled in other ways apparent to one of ordinary skill in the art.

With a constructed base 120 and lid 160, the method of assembling a container further includes inserting one or more animals into the assembled base 120. The method may further include preparing the container for shipment before or after inserting one or more animals into the assembled base 120.

The method of assembling a container further includes closing the container 100. The closing of the container may include placing a constructed lid 160 onto the assembled base 120 with one or more animals disposed in the base 120. The closing of the container may further include wrapping flaps 182 of the lid 160 around the flange panels 126 of the base 120. The closing of the container may further include fastening the flaps 182 to the flange panels 126 of the base 120 with one or more mechanical fasteners (e.g., staples, clips, bolts, screws, etc.). In some implementations of the method, the container may be closed by otherwise securing the lid 160 to the base 120 in other ways apparent to one of ordinary skill in the art (e.g., glue, tape, adhesive, etc.).

Further steps of constructing a lid for a container are further discussed with references to the example embodiments in the figures. Referring to FIGS. 11A-11B, the constructing of a lid 160 for a container 100 may include providing a first layer 180 comprising at least one opening 190 and a removable tear strip 195; coupling a support layer 220 to the first layer 180, covering the at least one opening 190 (See FIG. 11A); and coupling a transparent layer 200 to the first layer 180, covering the support layer 220 (See FIG. 11B).

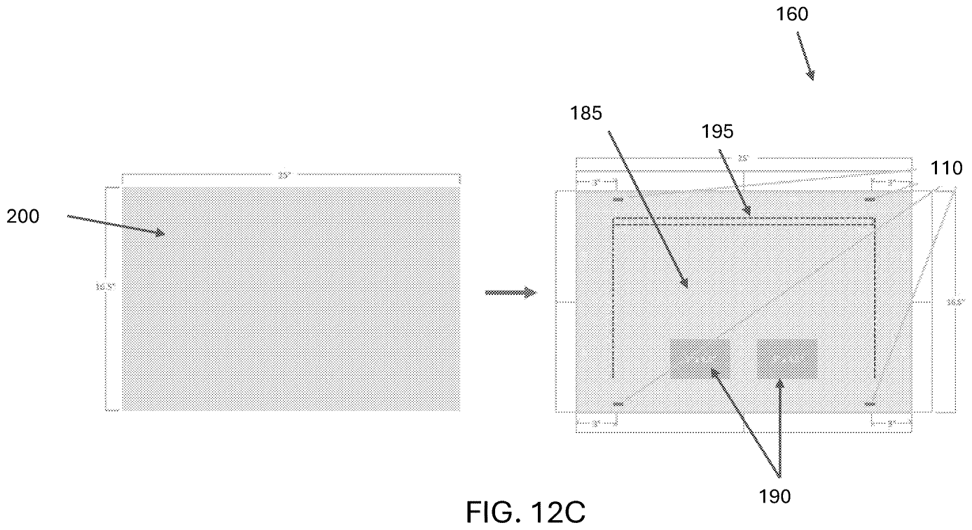

In another embodiment, now referring to FIGS. 12A-12C, the method of constructing a lid 160 may include coupling a first support layer 220a to the first layer 180 covering the at least one opening 190 (See FIG. 12A); coupling a second support layer 220b to the first layer 180 covering a portion of the first layer 180 (See FIG. 12B); and coupling a transparent layer 200 to the first layer 180 covering the first support layer 220a and the second support layer 220b (See FIG. 12C). In some implementations, the coupling may comprise fastening using a fastening mechanism (e.g., staples, clips, bolts, screws, etc.). Alternatively, the coupling may comprise adhering two or more components with an adhesive (e.g., glue, tape, resin, etc.).

In a further embodiment, a method of preparing a container for shipment is provided. The method includes at least providing a container 100 or a constructed base 120 according to any embodiment herein; placing one or more animals into the interior volume of the container; and securing the lid of the container to the base of the container. The method may further include inserting bedding into the bottom of the container 100. The method may further include inserting and/or securing one or more food sources, water sources, or additional contents into the interior volume of the container.

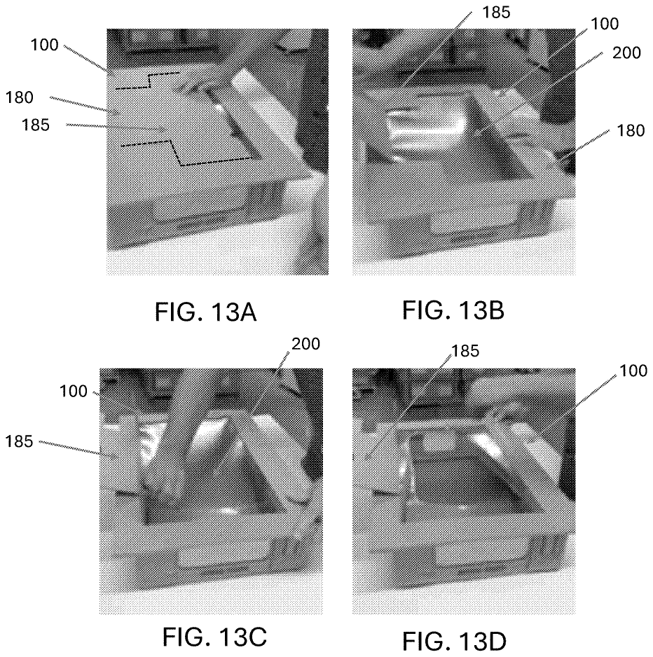

In a further embodiment, a method of retrieving an animal from a container is provided. The method of retrieving includes at least receiving a container according to any embodiment herein; opening the container; and removing at least one animal from the interior volume of the container. As depicted in FIGS. 13A-13D, the opening step of the method may further include removing the tear strip 195 of the first layer 180 (See FIG. 13A). The perforations in the first layer 180 allowing the removal of the removable tear strip 195 are configured to improve the stability of the container during the steps of opening the container. The removable tear strip 195 thus provides an easy-open option with minimal force required to remove the removable tear strip 195 and access the interior volume. The removable tear strip 195 thus reduces the shaking, vibrations, and manipulations to the container during the step of opening the container, reducing the stress caused to the one or more animals. That is, stability of the container is maintained while the removable tear strip 195 is removed and the lid is opened. In some implementations, the removable tear strip 195 may additionally reduce the noise generated by opening the container compared to conventional methods which include ripping the lid from the base. In some implementations, the transparent layer may help reduce noise transmission into the interior volume of the container from the removal of the removable tear strip 195.

The opening step of the method may include lifting and/or folding the access portion 185 of the first layer 180 (See FIG. 13B). The opening step of the method may further include exposing the transparent layer 200 of the lid. The opening step of the method may further include cutting the transparent layer of the lid (See FIG. 13C). The step of removing at least one animal may further include removing the at least one animal through the cut in the transparent layer (See FIG. 13D, animals not shown).

In a further embodiment of the method of retrieving an animal, the cutting of the transparent layer is performed with a cutting implement provided with the container. In a further embodiment, the container and the cutting implement are provided together in a kit (See FIG. 9).

### Example Embodiment 1

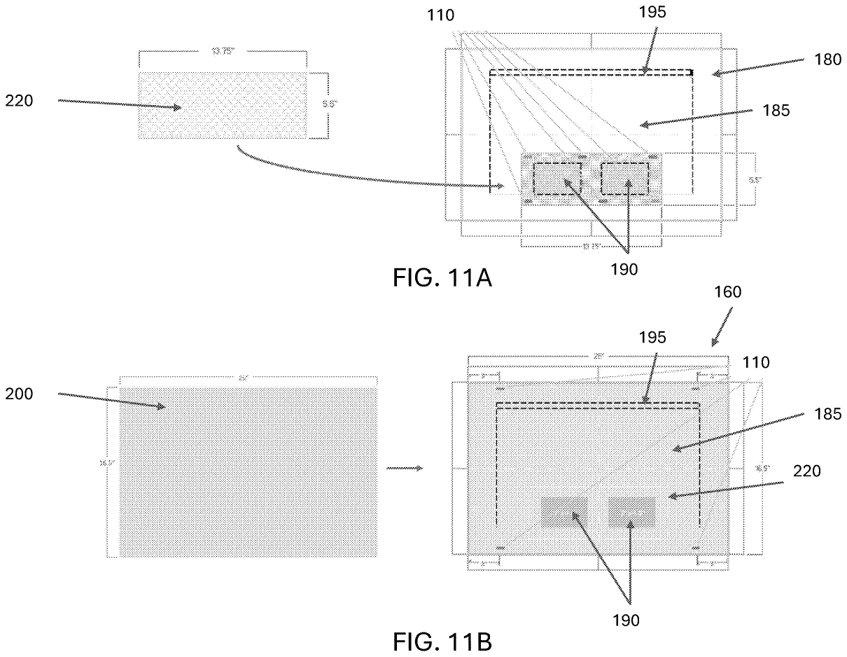

FIG. 10 illustrates a first example embodiment of a first layer of a lid. In the first example embodiment, the main portion 184 has an overall height of 16.625 inches and an overall width of 25 inches. Each of the flaps 182 extend from the main portion 184 by 1.5 inches. The access portion 185 is formed by the perforated sides 186 and one other side 187. The other side 187 has a length of 19.75 inches and is disposed 2.625 inches from a bottom edge of the main portion 184. The perforated sides 186 are 12 inches in length and disposed 2.625 inches from side edges of the main portion 184. The removable tear strip 195 is formed at the top of the access portion 185 and also has a length of 19.75 inches. The removable tear strip 195 is disposed 2 inches from a top edge of the main portion 184. The removable tear strip 195 is formed between two parallel perforations and has a width of 0.5 inches. The at least one opening 190 includes two openings in the access portion 185. Each opening 190 is disposed 7 inches from the side edges of the main portion 184. Each at least one opening 190 is disposed with one edge along the non-perforated side 187 of the access portion 185. There is a 2 inch gap between the two openings 190.

FIGS. 11A-B illustrate a method of assembling a first example embodiment of a lid with the first lid of FIG. 10. As shown in FIG. 11A, the support layer 220 is first attached to the first layer 180. The support layer 220 has a width of 13.75 inches and a height of 5.5 inches. The support layer 220 is placed symmetrically over the two openings 190 and secured in place. The support layer 220 is secured with six fasteners 110. The fasteners 110 are disposed approximately 0.5 inches from the edges of the support layer 220.

As shown in FIG. 11B, the transparent layer 200 is attached to the first layer 180 after the support layer 220. The transparent layer 200 has a width of 25 inches and a height of 16.5 inches. The transparent layer 200 is placed substantially covering the main portion 184 of the first layer 180 and secured in place. The transparent layer 200 is secured with four fasteners 110. The fasteners 110 are disposed approximately 0.75 inches from the top and bottom edges of the transparent layer 200 and 3 inches from the left and right edges of the transparent layer 200. With the transparent layer 200 secured in place, the first example embodiment of the lid 160 is complete. The lid 160 is ready for attachment to a base 120 of a container 100.

FIGS. 12A-C illustrate a method of assembling a second example embodiment of a lid with the first layer of FIG. 10. As shown in FIG. 12A, the first support layer 220a is first attached to the first layer 180. The first support layer 220 a has a width of 19.5 inches and a height of 13.75 inches. The first support layer 220a is placed symmetrically to cover the access portion 185 and extending to the bottom edge of the main portion 184 and then secured in place. The first support layer 220a is secured with five fasteners 110. Three fasteners 110 are disposed towards the removable tear strip 195 at 0.75 inches from the removable tear strip 195. Two fasteners 110 are disposed centered respectively above top edge of the two openings 190 at 0.75 inches from the top edges.

As shown in FIG. 12B, the second support layer 220b is then attached to the first layer 180. The second support layer 220b is formed by three rectangular panels. The second support layer 220 b includes two side panels having a height of 16.5 inches and width of 3.5 inches; and one top panel having a height of 3.5 inches and a width of 25 inches. The three panels are placed over the main portion 184 of the first layer 180 and secured in place. The top panel is placed along the top edge of the main portion 184 and the side panels are placed along the side edges of the main portion 184. This placement creates an overlap with the first support layer 220 a of approximately 0.875 inches. Each panel of the second support layer 220b is secured with two fasteners 110 placed approximately 1.5 inches from the edges of the main portion 184. Each panel of the support layer 220 also includes a folded inside edge. Thus, the panels support layer 220 may initially be provided with larger dimensions, and folded to create the dimensions shown. Support layers of other embodiments discussed throughout the disclosure may contain similar folds in order to achieve desired dimensions.

As shown in FIG. 12C, the transparent layer 200 is attached to the first layer 180 after the support layer 220. The transparent layer 200 has a width of 25 inches and a height of 16.5 inches. The transparent layer 200 is placed substantially covering the main portion 184 of the first layer 180 and secured in place. The transparent layer 200 is secured with four fasteners 110. The fasteners 110 are disposed approximately 0.75 inches from the top and bottom edges of the transparent layer 200 and 3 inches from the left and right edges of the transparent layer 200. With the transparent layer 200 secured in place, the first example embodiment of the lid 160 is complete. The lid 160 is ready for attachment to a base 120 of a container 100.

Clause 1. A container for transporting live animals comprising: a base; a lid; and an interior volume defined by the base and the lid, wherein the lid further comprises: a first layer including an access area of the first layer; at least one opening in the first layer such that a portion of the interior volume is visible through the at least one opening; and a removable tear strip in the first layer.

Clause 2. The container of clause 1, wherein the access area is configured to assume a folded configuration forming a flap when the tear strip is removed.

Clause 3. The container of clause 2, wherein the access area is defined by three perforated sides and a non-perforated side, such that the access area is configured to fold about the non-perforated side to form the flap.

Clause 4. The container of clause 2 or claim 3, wherein the tear strip is defined by two parallel perforated sides such that the tear strip is configured to be detached from the lid when the parallel perforated sides are torn.

Clause 5. The container of any one of clauses 2-4, wherein the lid further comprises a transparent layer and a support layer, and the wherein the first layer comprises a main portion and flaps extending from the main portion.

Clause 6. The container of clause 5, wherein the support layer is configured to cover an entire area of the at least one opening of the first layer.

Clause 7. The container of clause 5 or claim 6, wherein the support layer is configured to cover an entire area of the access area.

Clause 8. The container of any one of clauses 5-7, wherein the transparent layer is configured to cover an entire area of the main portion of the first layer.

Clause 9. The container of any one of clauses 5-8, wherein the support layer is disposed between the transparent layer and the first layer.

Clause 10. The container of any one of clauses 5-9, wherein the support layer is secured to the access area of the first layer and is disposed such that it does not cover any of the three perforated sides of the access area.

Clause 11. The container of any one of clauses 5-10, wherein the transparent layer is composed of bi-axially oriented polyethylene terephthalate.

Clause 12. The container of any one of clauses 5-11, wherein the support layer is a film, a sheet, or a mesh, and is composed of a metal, plastic, or fiberglass.

Clause 13. The container of any one of clauses 5-12, wherein the support layer comprises a first support layer and a second support layer.

Clause 14. The container of clause 13, wherein the first support layer is configured to cover an entire area of the access area, and the second support layer is configured to overlap a portion of the first support layer.

Clause 15. The container of any one of clauses 13-14, wherein the first support layer and the second support layer together cover an entire area of the main portion of the first layer.

Clause 16. The container of any one of clauses 13-15, wherein the transparent layer is configured to cover substantially all of the first support layer and substantially all of the second support layer.

Clause 17. The container of any one of clauses 13-16, the first support layer is secured to the access area of the first layer and is disposed such that it does not cover any of the three perforated sides of the access area.

Clause 18. The container of any one of clauses 13-17, wherein the second support layer is secured to the first layer and is configured to remain stationary when the access area is opened.

Clause 19. The container of any one of clauses 13-18, wherein the first support layer is disposed between the second support layer and the first layer.

Clause 20. The container of any one of clauses 1-19, wherein the at least one opening comprises two or more openings.

Clause 21. The container of any one of clauses 1-20, wherein the least one opening is defined by four connected sides, each side formed from a cut in the first layer.

Clause 22. The container of any one of clauses 1-21, wherein the at least one opening has an area in a range of 11-16 in2.

Clause 23. The container of any one of clauses 1-22, wherein the interior volume comprises a first subvolume and second subvolume separated from the first subvolume via a first interior wall, and wherein a portion of the first subvolume and a portion of the second subvolume are each visible through the at least one opening.

Clause 24. The container of clause 23, wherein the interior volume further comprises a third subvolume separated from the first subvolume and the second subvolume via a second interior wall, and wherein a portion of the third subvolume is visible through the at least one opening.

Clause 25. The container of any one of clauses 1-24, wherein the tear strip is disposed along a lateral edge of the access area.

Clause 26. The container of any one of clauses 5-25, wherein the base includes: a first panel; and a plurality of sidewalls extending substantially perpendicularly from the first panel towards a top end; wherein each sidewall of the plurality of sidewalls includes a flange extending substantially perpendicular to the sidewall.

Clause 27. The container of clause 26, wherein the flaps of the lid are configured to surround the flanges.

Clause 28. The container of clause 27, further comprising mechanical fasteners configured to fix the flaps to the flanges.

Clause 29. The container of any one of clauses 26-28, wherein the base further includes a base perforation, such that the flanges of the base are removable from the sidewalls.

Clause 30. The container of clause 29, wherein the lid and flanges of the base are configured to be removed from the base when the lid is mechanically fastened to a top portion of the base in response to tearing of the base perforation.

Clause 31. The container of any one of clauses 5-30, wherein the access area has an area which is at least 40% of an area of the main portion of the first layer.

Clause 32. A container for transporting live animals comprising: a base defining an interior volume; and a lid comprising: a first layer comprising an access area and a removable tear strip, the access area including at least one opening such that a portion of the interior volume is visible through the at least one opening, wherein the removable tear strip is configured to be removed from the first layer while maintaining stability of the container.

Clause 33. The container of clause 32, wherein the lid further comprises a transparent layer configured to isolate the interior volume from the first layer.

Clause 34. The container of clause 33, wherein the transparent layer is configured to be cut to allow access to the interior volume substantially without causing any disturbances to the container.

Clause 35. A method of preparing a container for shipment comprising: (a) providing a container according to any one of clauses 1-34; (b) placing at least one animal into the interior volume of the container; and (c) securing the lid to the base.

Clause 36. A method of retrieving an animal from a container comprising: (a) receiving a container according to any one of clauses 5-34; and (b) removing at least one animal from the interior volume of the container.

Clause 37. The method of clause 36, wherein the removing comprises: i. exposing the transparent layer of the lid; ii. cutting the transparent layer of the lid; and iii. removing the at least one animal through the cut in the transparent layer.

Clause 38. The method of clause 37, wherein the cutting is performed with a cutting implement comprising a knife.

Clause 39. The method of any one of clauses 37-38, wherein the exposing includes removing the tear strip from the lid and folding the access area of the first layer.

Clause 40. A method of retrieving an animal from a container comprising: (a) receiving a container according to clause 30; and (b) removing at least one animal from the interior volume of the container, wherein the removing comprises removing the lid and the top portion of the base from the base.

Clause 41. A kit for transporting live animals comprising: (a) a base; (b) a lid configured to fasten to the base to define an interior volume, the lid comprising: i. a first layer having an access area and a removable tear strip, wherein the access area is configured to form a flap when the tear strip is removed; and ii. a transparent layer configured to fasten to the first layer; and (c) a cutting implement for cutting the transparent layer of the lid.

Clause 42. A kit for transporting live animals comprising: (a) a container according to any one of clauses 5-34; and (b) a cutting implement for cutting the transparent layer of the lid.

Clause 43. The kit of clause 41 or 42, wherein the cutting implement comprises a knife.

Clause 44. A method of assembling a lid for a container comprising: (a) providing a first layer comprising at least one opening and a removable tear strip; (b) fastening a support layer to the first layer, covering the at least one opening; and (c) fastening a transparent layer to the first layer, covering the support layer.

Clause 45. A method of assembling a lid for a container comprising: (a) providing a first layer comprising at least one opening and a removable tear strip; (b) fastening a first support layer to the first layer, covering the at least one opening; (c) fastening a second support layer to the first layer covering a portion of the first support layer and the tear strip; and (d) fastening a transparent layer to the first layer, covering the first support layer, the second support layer.

Clause 46. A method of assembling a container comprising: (a) assembling a base, wherein assembling the base further comprises: folding a plurality of sidewalls perpendicularly from a first panel; and folding flange panels perpendicular to the sidewalls to form a base flange; (b) disposing a lid on the base; (c) wrapping flaps of the lid around the flange panels of the base; and (d) securing the lid to the base by inserting one or more fasteners through the flaps of the lid and the flange panels of the base.

Clause 47. The method of clause 46, further comprising: placing a pad in the base before securing the lid to the base.

Clause 48. The method of clause 46 or 47, further comprising placing an animal in the base before securing the lid to the base.

Clause 49. The method of any one of clauses 46-48, further comprising: securing at least one filter to an interior surface of the base, covering at least one filter opening in the base.

Clause 50. The method of clause 49, further comprising: fastening a filter support layer to an interior surface of the base, covering the at least one filter.

Having thus described several aspects of at least one embodiment of this invention, it is to be appreciated that each of the features discussed herein relating to the construction of a container for transporting live animals results in an improved transportation container and methods of use. The containers and methods herein are intended to reduce the noise and vibrations transmitted to the one or more animals, create easy-to-use operation of the container, and ensure the safety of the one or more animals and the public during the transportation. It is to be further appreciated that various alterations, modifications, and improvements to the container and methods will readily occur to those skilled in the art. Such alterations, modifications, and improvements are intended to be part of this disclosure, and are intended to be within the spirit and scope of the invention. In addition, various features from one of the embodiments may be incorporated into another of the embodiments. Accordingly, it is appropriate that the appended claims be construed broadly and in a manner consistent with the scope of the disclosure as set forth in the following claims, and that the foregoing description and drawings are by way of example only.

Unless otherwise defined herein, scientific and technical terms used in the present disclosure shall have the meanings that are commonly understood by one of ordinary skill in the art. Further, unless otherwise required by context, singular terms shall include pluralities, and plural terms shall include the singular.

The articles “a” and “an” are used herein to refer to one or to more than one (i.e., to at least one) of the grammatical object of the article. By way of example, “an element” means one element or more than one element.

The terms “invention” or “present invention” are non-limiting terms and are not intended to refer to any single aspect of the particular invention, but encompass all possible aspects as described in the specification and the claims.

The use of the term “or” in the claims is used to mean “and/or,” unless explicitly indicated to refer only to alternatives or the alternatives are mutually exclusive, although the disclosure supports a definition that refers to only alternatives and “and/or.”

As used herein, the terms “comprising” (and any variant or form of comprising, such as “comprise” and “comprises”), “having” (and any variant or form of having, such as “have” and “has”), “including” (and any variant or form of including, such as “includes” and “include”) or “containing” (and any variant or form of containing, such as “contains” and “contain”) are inclusive or open-ended and do not exclude additional, unrecited, elements or method steps.

The use of the term “for example” and its corresponding abbreviation “e.g.” means that the specific terms recited are representative examples and embodiments of the disclosure that are not intended to be limited to the specific examples referenced or cited unless explicitly stated otherwise.

The term “comprises” and its derivations (such as “comprising,” etc.) should not be understood in an excluding sense, that is, these terms should not be interpreted as excluding the possibility that what is described and defined may include further elements, steps, etc. Meanwhile, when used herein, the term “approximately” and terms of its family (such as “approximate,” etc.) should be understood as indicating values very near to those which accompany the aforementioned term. For example, 5%, 10%, 15% or 20% of the given value. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

As used herein, “between” is a range inclusive of the ends of the range. For example, a number between x and y explicitly includes the numbers x and y and any numbers that fall within x and y.

As may be used herein any terms referring to geometrical relationships such as “vertical”, “horizontal”, “opposite”, “straight”, “lateral”, “parallel”, “perpendicular”, and other angular relationships denote also approximate yet functional and/or practical, respective relationships.

As may be used herein, the terms “preferred”, “preferably”, “typical”, “typically”, or “optionally” do not limit the scope of the invention or embodiments thereof.

1. A container for transporting live animals comprising:
a base;
a lid; and
an interior volume defined by the base and the lid, wherein the lid further comprises:
a first layer including an access area of the first layer;
at least one opening in the first layer such that a portion of the interior volume is visible through the at least one opening; and
a removable tear strip in the first layer,
wherein the access area is configured to assume a folded configuration forming a flap when the tear strip is removed.

2. (canceled)

3. The container of claim 1, wherein the access area is defined by three perforated sides and a non-perforated side, such that the access area is configured to fold about the non-perforated side to form the flap.

4. (canceled)

5. The container of claim 1, wherein the lid further comprises a transparent layer and a support layer, and the wherein the first layer comprises a main portion and flaps extending from the main portion.

6.-8. (canceled)

9. The container of claim 5, wherein the support layer is disposed between the transparent layer and the first layer.

10. The container of claim 5, wherein the support layer is secured to the access area of the first layer and is disposed such that it does not cover any of the three perforated sides of the access area.

11. The container of claim 5, wherein the transparent layer is composed of bi-axially oriented polyethylene terephthalate.

12. The container of claim 5, wherein the support layer is a film, a sheet, or a mesh, and is composed of a metal, plastic, or fiberglass.

13. The container of claim 5, wherein the support layer comprises a first support layer and a second support layer.

14. The container of claim 13, wherein the first support layer is configured to cover an entire area of the access area, and the second support layer is configured to overlap a portion of the first support layer.

15. The container of claim 13, wherein the first support layer and the second support layer together cover an entire area of the main portion of the first layer.

16. The container of claim 13, wherein the transparent layer is configured to cover substantially all of the first support layer and substantially all of the second support layer.

17. The container of claim 13, the first support layer is secured to the access area of the first layer and is disposed such that it does not cover any of the three perforated sides of the access area.

18. The container of claim 13, wherein the second support layer is secured to the first layer and is configured to remain stationary when the access area is opened.

19.-22. (canceled)

23. The container of claim 1, wherein the interior volume comprises a first subvolume and second subvolume separated from the first subvolume via a first interior wall, and wherein a portion of the first subvolume and a portion of the second subvolume are each visible through the at least one opening.

24. (canceled)

25. The container of claim 1, wherein the tear strip is disposed along a lateral edge of the access area.

26. The container of claim 5, wherein the base includes:
a first panel; and
a plurality of sidewalls extending substantially perpendicularly from the first panel towards a top end;
wherein each sidewall of the plurality of sidewalls includes a flange extending substantially perpendicular to the sidewall; and
wherein the flaps of the lid are configured to surround the flanges, and the container further comprises mechanical fasteners configured to fix the flaps to the flanges.

27.-28. (canceled)

29. The container of claim 26, wherein the base further includes a base perforation, such that the flanges of the base are removable from the sidewalls, wherein the lid and flanges of the base are configured to be removed from the base when the lid is mechanically fastened to a top portion of the base in response to tearing of the base perforation.

30.-35. (canceled)

36. A method of retrieving an animal from a container, the method comprising:
(a) receiving a container according to claim 5; and
(b) removing at least one animal from the interior volume of the container, wherein the removing comprises:
i. exposing the transparent layer of the lid;
ii. cutting the transparent layer of the lid; and
iii. removing the at least one animal through the cut in the transparent layer.

37.-40. (canceled)

41. A kit for transporting live animals comprising:
(a) a base;
(b) a lid configured to fasten to the base to define an interior volume, the lid comprising:
i. a first layer having an access area and a removable tear strip, wherein the access area is configured to form a flap when the tear strip is removed; and
ii. a transparent layer configured to fasten to the first layer; and
(c) a cutting implement for cutting the transparent layer of the lid.

42.-43. (canceled)

44. A method of assembling a lid for a container comprising:
(a) providing a first layer comprising at least one opening and a removable tear strip;
(b) fastening a support layer to the first layer, covering the at least one opening; and
(c) fastening a transparent layer to the first layer, covering the support layer.

45.-50. (canceled)
